(19) United States
(12) Patent Application Publication
(10) Pub. No.: US 2015/0293410 A1
(43) Pub. Date: Oct. 15, 2015

(54) LIQUID CRYSTAL DISPLAY DEVICE AND METHOD FOR MANUFACTURING SAME

(71) Applicant: Sharp Kabushiki Kaisha, Osaka-shi, Osaka (JP)

(72) Inventors: Takeshi NOMA, Osaka-shi (JP); Youhei NAKANISHI, Osaka-shi (JP); Masanobu MIZUSAKI, Osaka-shi (JP); Masayuki KANEHIRO, Osaka-shi (JP)

(21) Appl. No.: 14/424,463

(22) PCT Filed: Aug. 22, 2013
(86) PCT No.: PCT/JP2013/072405

§ 371 Date: Feb. 27, 2015

(30) Foreign Application Priority Data
Aug. 30, 2012 (JP) 2012-190645

(51) Int. Cl. G02F 1/1337; G02F 1/1339

(52) U.S. Cl. CPC G02F 1/133788; G02F 1/1339; G02F 1/133711; G02F 2001/133742

(57) ABSTRACT

The present invention provides a liquid crystal display device that exhibits sufficiently excellent display qualities, has sufficient adhesive strength between the pair of substrates, and has excellent reliability; and a method for producing the same. In the liquid crystal display device, at least one of the pair of substrates (11, 21) is provided with, on the liquid crystal layer (30) side, an electrode, a first alignment control layer (13, 23), and a second alignment control layer (15, 25), the first alignment control layer (13, 23) including an outer edge that is on the inner side relative to an inner periphery of the sealing material (S) in a plan view of the main surfaces of the pair of substrates, the liquid crystal display device including, in a display region, a region without the first alignment control layer (13, 23), the second alignment control layer (15, 25) partially covering the first alignment control layer (13, 23), and including an outer edge that is on the outer side relative to the outer edge of the first alignment control layer (13, 23) in a plan view of the main surfaces of the pair of substrates.

### TECHNICAL FIELD

The present invention relates to a liquid crystal display device and a method for producing the same. The present invention more specifically relates to a narrow-frame liquid crystal display device, and a method for producing the same.

### BACKGROUND ART

Liquid crystal display devices have been widely spread as light weight, thin-profile, and low power display devices, and are indispensable in everyday life and business as a display for devices such as mobile devices (e.g. smartphones, tablets), various monitors, and large-sized televisions. For such liquid crystal display devices, developments have been made to widen the viewing angle and increase the contrast, thereby further improving the display qualities, and also to provide more functions to the devices.

Current liquid crystal display devices control the alignment of liquid crystal molecules by applying an electric field to the liquid crystal material to change the polarization condition of light passing through the liquid crystal layer, thereby controlling the amount of light passing through the polarizing plate.

The display qualities of liquid crystal display devices are affected by the alignment conditions of liquid crystal molecules upon application of an electric field, and the size and direction of the applied electric field. For such liquid crystal display devices, various display modes are available which are different in terms of the alignment conditions of the liquid crystal molecules with no applied electric field and the application directions of electric fields.

Examples of the display modes for liquid crystal display devices include a vertical alignment (VA) mode in which liquid crystal molecules having a negative anisotropy of dielectric constant are aligned perpendicularly to the substrate surfaces; an in-plane switching (IPS) mode in which liquid crystal molecules having a positive or negative anisotropy of dielectric constant are aligned in parallel to the substrate surfaces, and a transverse electric field is applied to the liquid crystal layer; and a fringe field switching (FFS) mode.

The examples also include a multi-domain vertical alignment (MVA) mode in which liquid crystal molecules having a negative anisotropy of dielectric constant are used and ribs and electrode slits are provided as alignment control structures. The MVA mode can control the liquid crystal alignment directions to multiple directions while an electric field is applied without rubbing treatment on the alignment film, and exhibits an excellent viewing angle. However, conventional MVA liquid crystal display devices can still be improved in that the upper portions of the ribs or slits form boundaries of alignment divisions for liquid crystal molecules, and thus they have a low transmittance in white display which can results in dark lines in display.

A method for obtaining a liquid crystal display device capable of achieving a high luminance and a high response speed suggested in documents such as Patent Literature 1 is an alignment stabilization technology using polymers (hereinafter, also referred to as a polymer sustained (PS) technology).

Narrow-frame liquid crystal panels that can provide a larger display area than in liquid crystal display devices have also been actively developed in recent years.

For example, Patent Literature 2 discloses a liquid crystal display device including: a first substrate; a second substrate which is arranged to face the first substrate in an opposed manner; a sealing material which adheres the first substrate and the second substrate to each other; and liquid crystal which is sandwiched between the first substrate and the second substrate; wherein the first substrate includes: pixel electrodes which are formed inside a display region; an orientation film which is formed at a position where the orientation film is brought into contact with the liquid crystal; a plurality of projections which is formed of a first insulation film below the orientation film in a region inside the sealing material and outside the display region; a second insulation film which is arranged at a position where the second insulation film overlaps the plurality of projections and below the first insulation film, and is formed of a material to be etched by an etching gas which forms the first insulation film into the plurality of projections; and a first stopper layer which is formed at a position where the first stopper layer overlaps the plurality of projections and between the first insulation film and the second insulation film, the first stopper layer being formed of a material which possesses etching selection property for the etching gas and protecting the second insulation film from the etching gas, and assuming a width of the sealing material as W1 and an overlapping width of the orientation film and the sealing material as W2, a relationship W2≦W1/2 is established.

### CITATION LIST

### Patent Literature

Patent Literature 1: JP 2010-33093 A
Patent Literature 2: JP 2008-145461 A

### SUMMARY OF INVENTION

### Technical Problem

Decreasing the width of the sealing material in order to produce a narrow-frame liquid crystal display panel unfortunately results in a decrease in the adhesive strength between the pair of substrates of the liquid crystal panel and a decrease in the reliability of a humidity test.

With a conventional sealing material with a large width W1, alignment films (polyimide) 513 and 523 can be formed such that the alignment films are not positioned under the sealing material S1 (e.g. FIG. 22). However, in the case of a sealing material S2 which is thinner and has a smaller width W2 than the sealing material S1, the insufficient formation precision of alignment films 313 and 323 results in formation of the alignment films 313 and 323 under the entire sealing material S2 (e.g. FIG. 23).

In the case that the alignment films 313 and 323 are formed under the sealing material S2 as illustrated in FIG. 23, the adhesive strength between the sealing material S2 and the alignment films 313 and 323 is low, which gives low adhesive strength between the pair of substrates of the liquid crystal panel.

Also, moisture w enters the liquid crystal panel through the alignment films 313 and 323, decreasing the reliability of the liquid crystal panel.

Patent Literature 2 discloses an invention related to a narrow-frame liquid crystal panel in which projections and recesses for suppressing spread of the alignment film material during application of the alignment film material are provided in a region surrounded by the sealing material and outside the display region, so as to avoid overlapping of the sealing material and the alignment film (e.g. FIGS. 1 and 2 in Patent Literature 2). However, when projections and recesses for suppressing spread of the alignment film material are provided in a region outside the display region, this region is also included in the frame region which is a non-display region. Such a liquid crystal panel can still be improved to provide a liquid crystal display device having a high adhesive strength between the pair of substrates and being reliable, and further reduce the frame region.

The present invention has been made in view of the above current state of the art, and aims to provide a liquid crystal display device that exhibits excellent display qualities, has high adhesive strength between the pair of substrates, and has excellent reliability; and a method for producing the same.

### Solution to Problem

The present inventors have made various studies on liquid crystal display devices that exhibit high adhesive strength between a pair of substrates and have high reliability. As a result, they have focused on application of an alignment film material with a sufficient space from the site at which the sealing material is to be disposed such that the alignment film (first alignment control layer) is not formed under the sealing material (that is, the alignment film is prevented from coming under the sealing material even if the prevention leads to formation of a region without an alignment film within the active area (display region)). As a result, the liquid crystal molecules have been found to be aligned by addition of an additive to the polymer layer formed from monomers or to the liquid crystal in the region without an alignment film. Also, since alignment is already provided by the alignment film in some regions and, accordingly, if the monomers for forming the polymer layer are the same, the liquid crystal molecules can be more easily aligned and sufficient display qualities can be achieved, compared to panels with no alignment film. As described above, no alignment film is formed under the sealing material, and therefore the sealing material can be directly adhered to the substrate, between which the adhesive strength is high. Also, since the alignment film is not exposed on the side face of the liquid crystal panel, the alignment film does not come into contact with the external air. Accordingly, moisture can be prevented from entering the liquid crystal panel through the alignment film, and thus the liquid crystal display device has excellent reliability. Furthermore, even if uncured material components of the sealing material exude to the liquid crystal, the alignment film adsorbs the components. Hence, the exudation does not affect the reliability. The present inventors have found that such a liquid crystal display device can solve the above problems, arriving at the present invention.

The present invention is greatly different from the technology described in Patent Literature 2 in that the second alignment control region (e.g. polymer layer) is formed by, for example, mixing monomers into a liquid crystal, injecting the liquid crystal into a panel (cell), and irradiating the liquid crystal with ultraviolet (UV) light, such that alignment is provided also in the region without the first alignment control region formed by an alignment film. The present invention can further narrow the frame of the liquid crystal display device so as to widen the display region.

That is, one aspect of the present invention may be a liquid crystal display device including: a liquid crystal cell that includes a pair of substrates; a liquid crystal layer sandwiched between the pair of substrates; and a sealing material causing the pair of substrates to adhere to one another, the sealing material surrounding the liquid crystal layer in a plan view of main surfaces of the pair of substrates, at least one of the pair of substrates being provided with, on the liquid crystal layer side, an electrode, a first alignment control layer, and a second alignment control layer, the first alignment control layer including an outer edge that is on the inner side relative to an inner periphery of the sealing material in a plan view of the main surfaces of the pair of substrates, the liquid crystal display device including, in a display region, a region without the first alignment control layer, the second alignment control layer partially covering the first alignment control layer, and including an outer edge that is on the outer side relative to the outer edge of the first alignment control layer in a plan view of the main surfaces of the pair of substrates.

Preferably, the sealing material has a width of 1.0 mm or smaller in a plan view of the main surfaces of the substrates.

Preferably, the second alignment control layer is formed from a monomer unit derived from at least one of a monofunctional monomer and a polyfunctional monomer, the at least one monomer containing a C₈-C₂₀ alkyl group and a functional group that generates radicals by photoirradiation.

Preferably, a distance from the inner periphery of the sealing material to the first alignment control layer is 0.05 mm or longer.

Preferably, a distance from the inner periphery of the sealing material to the display region is 1.0 mm or shorter.

Preferably, at least part of an outer periphery of the sealing material and at least part of the outer edge of the pair of substrates match one another in a plan view of the main surfaces of the substrates.

Preferably, the liquid crystal molecules are aligned in a perpendicular direction to the main surfaces of the substrates when voltage applied to the liquid crystal molecules is lower than a threshold voltage.

Preferably, the liquid crystal molecules have a negative anisotropy of dielectric constant.

Another aspect of the present invention may be a method for producing a liquid crystal display device including a liquid crystal cell that includes a pair of substrates; a liquid crystal layer sandwiched between the pair of substrates, and a sealing material causing the pair of substrates to adhere to one another, the method comprising the steps of: forming a first alignment control layer for controlling alignment of liquid crystal molecules to bring an outer edge of the first alignment control layer on the inner side relative to an inner periphery of the sealing material; forming the sealing material; injecting a liquid crystal composition; annealing the liquid crystal cell; and forming a second alignment control layer including an outer edge that is on the outer side relative to the outer edge of the first alignment control layer by polymerization of monomers or by an agent in the liquid crystal composition.

Preferably, the step of forming a second alignment control layer includes polymerizing monomers by photoirradiation.

Preferably, the step of forming a second alignment control layer includes polymerizing monomers by a polymerization initiator.

Preferably, the step of forming a second alignment control layer includes forming the second alignment control layer by an additive containing a hydroxy group.

Preferably, the monomers constitute from 0.5% by mass to 2.5% by mass inclusive of the liquid crystal composition.

Preferably, the photoirradiation is performed by heating the liquid crystal composition to a temperature not lower than a temperature that is lower than the nematic-isotropic phase transition temperature (Tni) by 30° C.

The preferred embodiments of the liquid crystal display devices obtained by the method for producing a liquid crystal display device according to the present invention are the same as the preferred embodiments of the liquid crystal display device of the present invention.

The steps of the method for producing a liquid crystal display device according to the present invention are not especially limited by other steps as long as the method essentially includes such steps.

### Advantageous Effects of Invention

The present invention can provide a liquid crystal display device that exhibits excellent display qualities, has high adhesive strength between the pair of substrates, and has excellent reliability; and a method for producing the same.

### BRIEF DESCRIPTION OF DRAWINGS

FIG. 1 is a schematic cross-sectional view of a liquid crystal cell of Embodiment 1 before a photoirradiation step.

FIG. 2 is a schematic cross-sectional view of the liquid crystal cell of Embodiment 1 after the photoirradiation step.

FIG. 3 is a schematic plan view of the liquid crystal cell of Embodiment 1.

FIG. 4 is a photograph showing a liquid crystal cell of Experiment 1-1 before ultraviolet irradiation.

FIG. 5 is a photograph showing the liquid crystal cell of Experiment 1-1 after ultraviolet irradiation.

FIG. 6 is a photograph showing a liquid crystal cell of Experiment 1-2 before ultraviolet irradiation.

FIG. 7 is a photograph showing the liquid crystal cell of Experiment 1-2 after ultraviolet irradiation.

FIG. 8 is a photograph showing a liquid crystal cell of Experiment 1-3 before ultraviolet irradiation.

FIG. 9 is a photograph showing the liquid crystal cell of Experiment 1-3 after ultraviolet irradiation.

FIG. 10 is a schematic cross-sectional view of a liquid crystal cell of Embodiment 2.

FIG. 11 is a photograph showing the liquid crystal cell of Experiment 2 after injection of a liquid crystal composition to which an additive has been added.

FIG. 12 is a schematic cross-sectional view of a liquid crystal cell of Embodiment 3 before photoirradiation.

FIG. 13 is a schematic cross-sectional view of the liquid crystal cell of Embodiment 3 after photoirradiation.

FIG. 14 is a photograph showing a liquid crystal cell of Example 1 before ultraviolet irradiation.

FIG. 15 is a photograph showing the liquid crystal cell of Example 1 after ultraviolet irradiation.

FIG. 16 is a photograph showing a liquid crystal cell of Comparative Example 1 before ultraviolet irradiation.

FIG. 17 is a photograph showing the liquid crystal cell of Comparative Example 1 after ultraviolet irradiation.

FIG. 18 is a schematic perspective view illustrating a pair of substrates adhered to one another.

FIG. 19 is a schematic perspective view illustrating separation of the pair of substrates illustrated in FIG. 18 by pressure.

FIG. 20 is a schematic cross-sectional view of a liquid crystal cell of Comparative Experiment 1.

FIG. 21 is a schematic cross-sectional view of a liquid crystal cell of Experiment 3.

FIG. 22 is a schematic cross-sectional view of a conventional liquid crystal cell with a large width of a sealing material.

FIG. 23 is a schematic cross-sectional view of a conventional liquid crystal cell with a small width of a sealing material.

### DESCRIPTION OF EMBODIMENTS

The present invention will be described in more detail below with reference to the drawings based on embodiments which, however, are not intended to limit the scope of the present invention. Hereinafter, a substrate including thin film transistors (TFTs) is also referred to as an array substrate, and a substrate including color filters is also referred to as a color filter substrate (CF substrate). The alignment film is also referred to as a polyimide (PI) film in consideration of the material thereof, but the material is not limited to polyimide. The width of the sealing material and the distance between components may each be an average value. The display region is a region producing an image recognized by the observer, and does not include the peripheral region such as terminals. The nematic-isotropic phase transition temperature (Tni) means the phase transition temperature from a nematic phase to an isotropic liquid phase. What is meant by “the display region of the liquid crystal display device includes a region without the first alignment control layer” is that the display region of the liquid crystal display device includes a region without the first alignment control layer as in the case that, for example, the liquid crystal display device includes, in its display region, a part located on the outer side relative to the outer edge of the first alignment control layer. The liquid crystal composition is, for example, a combination of the liquid crystal and the monomers.

### Embodiment 1

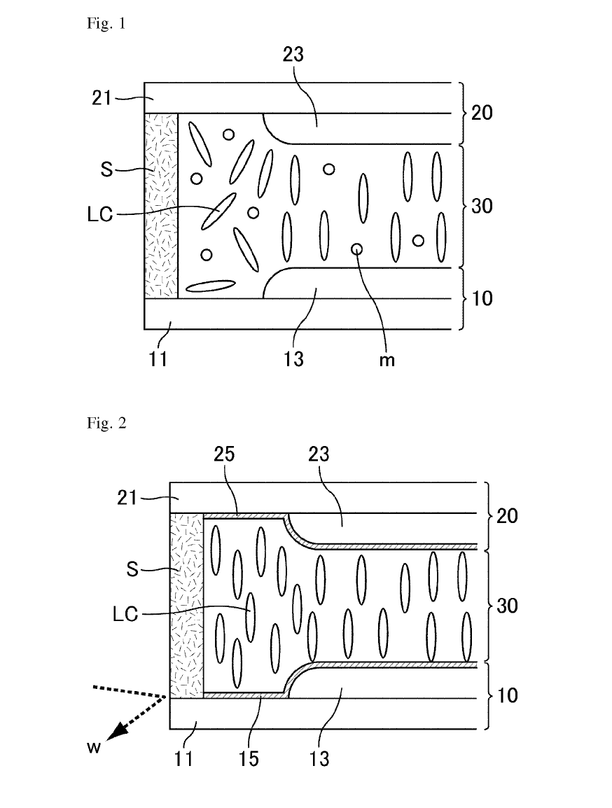

FIG. 1 is a schematic cross-sectional view of a liquid crystal cell of Embodiment 1 before photoirradiation.

The liquid crystal display device of Embodiment 1 is provided with a liquid crystal cell including a pair of substrates (TFT substrate 10 and CF substrate 20), liquid crystal molecules LC sandwiched between the pair of substrates, photopolymerizable monomers m, and a sealing material S causing the pair of substrates to adhere to one another. FIG. 1 illustrates a region in which part of the liquid crystal molecules is not vertically aligned yet. On the liquid crystal layer side of the TFT substrate 10, an electrode (not illustrated), and an alignment film 13 serving as the first alignment control layer are provided. Also, on the liquid crystal layer side of the CF substrate 20, an alignment film 23 serving as the first alignment film control layer is provided.

In Embodiment 1, an alignment film material is applied with a sufficient space from a position at which the sealing material S is to be placed so that each of the alignment films 13 and 23 as the first alignment control layers does not come under the sealing material S (e.g. the alignment film material is applied only to the region on the inner side relative to the outer edge of the display region). Thereby, the alignment films 13 and 23 are formed with the outer edge of the alignment film being on the inner side relative to the inner periphery of the sealing material S (preferably, on the inner side relative to the outer edge of the display region).

Then, the step of forming the sealing material S, the step of injecting the liquid crystal composition, and annealing the liquid crystal cell are sequentially performed.

The monomers preferably constitute from 0.5% by mass to 2.5% by mass inclusive of the liquid crystal composition.

FIG. 2 is a schematic cross-sectional view of the liquid crystal cell of Embodiment 1 after photoirradiation. In the region without the alignment films 13 and 23, monomers (the monomers m illustrated in FIG. 1) in the liquid crystal composition are polymerized by photoirradiation so that the polymer layer 15 and 25 are formed with the respective outer edges thereof being on the outer side relative to the outer edges of the alignment layers 13 and 23. With these polymer layers 15 and 25, the liquid crystal molecules in the region without the alignment layers 13 and 23 are aligned. Thereby, the liquid crystal molecules can be vertically aligned throughout the display region. The step of forming a polymer layer may utilize a polymerization initiator. Also, the photoirradiation is preferably performed by heating the liquid crystal composition to a temperature not lower than a temperature that is lower than the nematic-isotropic phase transition temperature by 30° C. The nematic-isotropic phase transition temperature (Tni) herein means the phase transition temperature from a nematic phase to an isotropic liquid phase.

In Embodiment 1, the liquid crystal cell already includes a region where alignment is provided by the alignment films 13 and 23 serving as the first alignment control layers, and thus easily aligns the liquid crystal molecules and provides sufficient display qualities, compared to a liquid crystal panel with no alignment film. Here, the alignment films 13 and 23 are not substantially formed under the sealing material S, and therefore the sealing material S can be directly adhered to the glass substrates 11 and 21, between which the adhesive strength is high. Also, since the alignment films 13 and 23 are not exposed on the side face of the liquid crystal panel, the alignment films 13 and 23 do not come into contact with the external air. Accordingly, moisture w can be prevented from entering the liquid crystal panel through the alignment films 13 and 23, and thus the liquid crystal display device has excellent reliability. Furthermore, even if uncured material components of the sealing material S exude to the liquid crystal, the alignment films 13 and 23 adsorb the components, and thus the influence on the reliability of the liquid crystal panel can be sufficiently reduced.

The polymer layers 15 and 25 as the second alignment control layers may be formed from a single or multiple kinds of monomers. For example, the polymer layers 15 and 25 are each preferably formed from a monomer unit derived from at least one of a monofunctional monomer and a polyfunctional monomer, the at least one monomer containing a C₈-C₂₀ alkyl group and a functional group that generates radicals by photoirradiation.

When the first alignment control layers and the second alignment control layers are provided which are vertical alignment films, the liquid crystal molecules LC are aligned perpendicularly to the main surfaces of the substrates with a voltage applied to the liquid crystal molecules being lower than a threshold voltage.

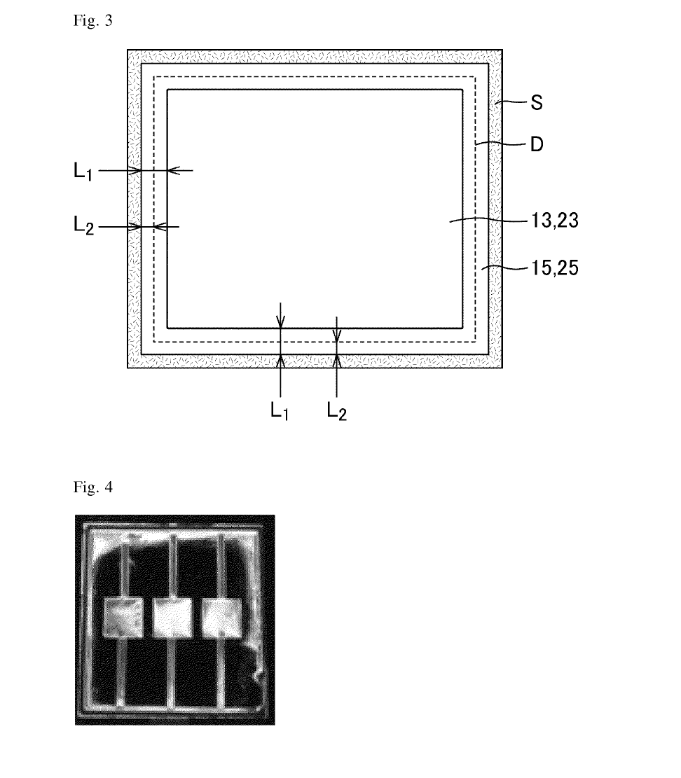

FIG. 3 is a schematic plan view of the liquid crystal cell of Embodiment 1. The sealing material S is provided to surround the liquid crystal layer (not illustrated) in a plan view of the main surfaces of the substrates.

The first alignment control layers 13 and 23 are formed so that the respective outer edges thereof are on the inner side relative to the inner periphery (inner edge) of the sealing material S in a plan view of the main surfaces of the substrates. The second alignment control layers 15 and 25 are formed such that the outer edges thereof extend along the inner periphery of the sealing material S and are on the outer side relative to the outer edges of the first alignment control layers 13 and 23 in a plan view of the main surfaces of the substrates. Here, what is meant by “the outer edges of the second alignment control layers 15 and 25 extend along the inner periphery of the sealing material S” is that the outer edges of the second alignment control layers 15 and 25 substantially match the inner periphery of the sealing material S. Also, the outer periphery of the sealing material S and the outer edges of the pair of substrates substantially match one another in a plan view of the main surfaces of the substrates, and thereby the frame region is small.

The distance L₁ from the inner periphery of the sealing material S to (the outer edges of) the first alignment control layers 13 and 23 is preferably 0.05 mm or longer. The upper limit for L₁ is preferably 0.5 mm. If L₁ is 0.5 mm or shorter, the effect of vertically aligning the liquid crystal molecules of the present invention can be sufficiently achieved.

The distance L₂ from the inner periphery of the sealing material S to the display region D is preferably 1.0 mm or shorter. The display region D includes a region without the first alignment control layers 13 and 23 (region surrounded by the outer edge of the display region D and the outer edges of the first alignment control layers 13 and 23).

The sealing material S preferably has a width of 1.0 mm or smaller in a plan view of the main surfaces of the substrates.

The present invention has no alignment film under the sealing material in a narrow-frame panel from the viewpoints of adhesive strength and reliability, and provides alignment to the non-aligned region by PI-less technology (e.g. FIG. 1 and FIG. 2). The PI-less technology irradiates, with ultraviolet light, the cell into which a liquid crystal composition mixed with a photopolymerizable monomer material has been injected, so that the liquid crystal molecules are vertically aligned.

That is, in Embodiment 1, polymers (second alignment control layers 15 and 25) obtained from monomers added to the liquid crystal vertically align the liquid crystal molecules.

Hereinafter, the preferred forms of the liquid crystal display device of Embodiment 1 are described in more detail.

The alignment control layers formed through photoirradiation steps such as the above ultraviolet irradiation step are layers for controlling alignment of liquid crystal molecules, and preferably vertically align the liquid crystal molecules with a voltage lower than the threshold voltage. The present invention is suitable for liquid crystal display devices that vertically align liquid crystal molecules, such as VA-mode liquid crystal display devices. Here, vertical alignment is not necessarily alignment that aligns the liquid crystal molecules at 90° to the surfaces of the substrates, if the pretilt angle of the liquid crystal layer is from 85° to 95° inclusive, preferably from 88° to 92° inclusive.

The second alignment control layers can be formed by polymerizing at least one of monofunctional monomers and polyfunctional monomers which are contained in a liquid crystal composition together with liquid crystal molecules when the liquid crystal composition is sandwiched between a pair of substrates. In this case, the second alignment control layers are mainly formed from polymers. The first alignment control layers and the second alignment control layers are each usually formed on one of the pair of substrates, i.e., between one of the pair of substrates and the liquid crystal layer. The first alignment control layers and the second alignment control layers can control alignment of liquid crystal molecules distributed in the liquid crystal layer, especially liquid crystal molecules close to the alignment control layers.

The monofunctional monomers are preferably monofunctional monomers containing one functional group that generates radicals by photoirradiation. The monofunctional monomers are preferably those represented by the following formula (1).

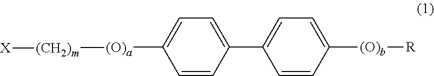

In the above formula (1), X represents an acrylate group, a methacrylate group, an ethacrylate group, a vinyl group, or an allyl group; m represents an integer of 0 to 12; a and b each independently represent 0 or 1; and R represents a C₁-C₂₀ alkyl group. Here, hydrogen atoms included in the ring structure may each independently be replaced by a halogen atom, a methyl group, an ethyl group, or a propyl group.

In order to form a polymer layer as the second alignment control layer, a polyfunctional group may be used together with or in place of the monofunctional group.

The polyfunctional monomer is a monomer containing at least two polymerization groups, i.e., polymerizable functional groups, in a molecule, and generates radicals by annealing and irradiation of light having a wavelength of 340 nm or longer.

Although the polyfunctional monomers are regarded as generating radicals when irradiated mainly with light having a wavelength of 340 nm or longer, the monomers could generate radicals only by annealing (heat treatment) without photoirradiation. The “annealing and irradiation of light having a wavelength of 340 nm or longer” herein include simultaneously performing annealing and photoirradiation, and also performing annealing and then performing photoirradiation when the temperature of the liquid crystal composition (liquid crystal cell) is higher than ordinary temperature (preferably a temperature not lower than a temperature that is lower than Tni by 30° C.)

The monofunctional monomers are represented by the above formula (1), and have one polymerization group in a molecule. The monofunctional monomers have a biphenyl skeleton which has a strong interaction with liquid crystal molecules. Also, two benzene rings bonded to one another are bonded at the respective position 1 and position 1′, and form a linear structure. The linear structure is stable because the structure includes no bend portions from the terminal functional groups (polymerization groups) to the biphenyl. The monofunctional monomers can therefore align the neighboring liquid crystal molecules by a stable alignment force.

That is, the alignment control layer has high alignment control force.

As a result, good alignment properties (suitably, alignment properties of vertical alignment) can be achieved, and therefore a liquid crystal display device having good display qualities with few bright points and bright lines can be obtained. Also, since the monofunctional monomers have poor volatility, it is possible to suppress volatilization of the monofunctional monomers even in vacuum when the liquid crystal composition is sandwiched between the substrates. Therefore, the production facility can be prevented from being contaminated.

The monofunctional monomers preferably function as parts having an alignment control ability in the alignment control layer after polymerization. That is, the structure derived from monofunctional monomers preferably controls the alignment of liquid crystal molecules in the alignment control layer.

The monofunctional monomers have an acrylate group, a methacrylate group, an ethacrylate group, a vinyl group, or an allyl group. Any of these functional groups can function as a polymerization group and generate radicals by photoirradiation. More specifically, the above functional groups can be cleaved by photoirradiation to generate radicals. Here, the polyfunctional monomers generate radicals by annealing and irradiation of light having a wavelength of 340 nm or longer. That is, both of the monofunctional monomers and the polyfunctional monomers can function also as a polymerization initiator. Therefore, supply of energy (e.g. heat, light) to the liquid crystal composition while the liquid crystal composition is sandwiched between the pair of substrates initiates the radical polymerization reaction, so that an alignment control layer is suitably formed.

However, in addition to the above at least one of monofunctional monomers and polyfunctional monomers, another polymerization initiator may be used.

The monomers include at least one kind of monofunctional monomers and polyfunctional monomers, and the number of the kinds of each of these monomers can be appropriately determined. The above monofunctional monomers and the polyfunctional monomers can be produced in the same manner as that for monomers used for typical alignment film-less technology. When the polymers constituting the second alignment control layer include a copolymer, the arrangement of the repeating units in the copolymer is not particularly limited, and may be random, block, or alternate arrangement, for example.

The average molecular weight of the polymers constituting the second alignment control layer is not particularly limited, and may be about the same as the number average molecular weight or the weight average molecular weight of the polymers formed by a typical alignment film-less technology. Typically, for example, the polymer preferably has a number of repeating units of 8 or more, for example.

The liquid crystal display device of Embodiment 1 may include a silane coupling layer between the second alignment control layer and the pair of substrates. The suitable forms of the silane coupling layer are the same as the suitable forms described later in Embodiment 3.

From the viewpoint of easily synthesizing the monofunctional monomers, a and b in the above formula (1) each preferably represent 1. In the above formula (1), R preferably represents a C₆-C₁₈ alkyl group. If the number of carbon atoms is 6 or greater, the liquid crystal molecules can be vertically aligned in a favorable manner. If the number of carbon atoms is 18 or smaller, the monomers are favorably dissolved in the liquid crystal composition.

In the above formula (1), m preferably represents an integer of 0 to 12, more preferably an integer of 0 to 10, and particularly preferably an integer of 0 to 8.

Although the specific structure of the polyfunctional monomers is not particularly limited if it is a structure capable of generating radicals by annealing and irradiation of light having a wavelength of 340 nm or longer and contains at least two polymerization groups. For example, the polyfunctional monomer can have a structure formed by condensation of at least three benzene rings (hereinafter, also referred to as a condensed ring structure). A condensed aromatic compound having at least three benzene rings can absorb light having a long wavelength (340 nm or longer) efficiently.

The liquid crystal composition may further contain a compound (polymerization initiator) that generates radicals by photoirradiation through a self-cleavage reaction. Use of such a compound enables polymerization with a smaller amount of irradiation.

The above compound typically has at least one radical polymerizable group. Use of such a compound (polymerization initiator with a polymerization group) enables polymerization of the compound itself, and thus can prevent generation of impurities from the polymerization initiator. Also, the polymerization can be completed by photoirradiation for a shorter time, and therefore deterioration of the constituent components due to long-time photoirradiation can be prevented.

Examples of the radical polymerizable groups include a (meth)acryloyloxy group, (meth)acryloylamino group, a vinyl group, and a vinyloxy group. The (meth)acryloyloxy group herein refers to an acryloyloxy group or a methacryloyloxy group, and the (meth)acryloylamino group refers to an acryloylamino group or a methacryloylamino group.

The pair of substrates typically includes an electrode on at least one of them, and can control whether or not to apply voltage to the liquid crystal layer. One of the pair of substrates may be an array substrate, and the other substrate may be a color filter substrate, for example. An array substrate is provided with a plurality of pixel electrodes arranged in a matrix, with which the alignment of the liquid crystal is controlled in each pixel. Examples of the electrode material include translucent materials such as indium tin oxide (ITO) and indium zinc oxide (IZO). A color filter substrate has sets of color filters of a plurality of colors at positions overlapping the respective pixel electrodes in the array substrate, with which colors to be displayed are controlled in each pixel.

The liquid crystal layer includes liquid crystal molecules, and is sandwiched between the pair of substrates. The properties of the liquid crystal layer and the liquid crystal molecules are not particularly limited, and may be appropriately set. Still, the liquid crystal layer is preferably a vertical alignment liquid crystal cell, and the liquid crystal molecules preferably have a negative anisotropy of dielectric constant. Thereby, for example, a vertical alignment (VA) liquid crystal display device having a high contrast ratio can be obtained. Here, in a vertical alignment liquid crystal layer, the liquid crystal molecules are aligned in a direction substantially perpendicular to the substrate surface when a voltage lower than the threshold voltage is applied, e.g., with no applied voltage. In the case that a vertical alignment liquid crystal layer having a negative anisotropy of dielectric constant is used, each of the pair of substrates is provided with an electrode, and whether or not voltage is applied to the liquid crystal layer by the electrodes is controlled, electric lines of force are generated in the direction substantially perpendicular to the substrate surface when a voltage not lower than the threshold voltage is applied. As a result, the liquid crystal molecules are aligned in the direction orthogonal to the electric lines of force, i.e. the direction substantially parallel to the substrate surface.

The kind of the liquid crystal molecules is not particularly limited and can be suitably selected. Still, nematic liquid crystal molecules are suitable. The number of the kinds of liquid crystal molecules may be one, or two or more.

The liquid crystal composition can contain a nematic phase and an isotropic liquid phase, and is preferably heated to a temperature not lower than a temperature that is lower than the nematic-isotropic phase transition temperature (Tni) by 30° C. in the photoirradiation step. For example, when the temperature at the time of photoirradiation is room temperature (30° C.), vertical alignment may not be achieved by irradiation at 5000 mJ/cm² or more, and the alignment may not change. This is probably because irradiation of light at a relatively low temperature cannot change the alignment due to the strong interaction between the monofunctional monomers and the liquid crystal molecules. The monofunctional monomers are more likely to be vertically aligned when the temperature is raised to easily cause molecular movements by thermal energy. As a result, the liquid crystal molecules can be vertically aligned more effectively. From such a viewpoint, the liquid crystal composition is more preferably heated to a temperature not lower than a temperature that is lower than Tni by 20° C., and particularly preferably to a temperature equal to or higher than Tni, in the photoirradiation step. The present inventors have actually verified that, when the temperature for the photoirradiation step is a temperature lower than Tni by 20° C., the liquid crystal molecules are vertically aligned after irradiation of light at 3000 mJ/cm².

The method for producing the liquid crystal display device of Embodiment 1 is described in detail below.

The above alignment film is preferably subjected to alignment treatment, but is not limited to those having been subjected to alignment treatment. Examples of the alignment film having been subjected to alignment treatment include those having been subjected to rubbing treatment or photoalignment treatment.

After the substrate washing, the alignment film material is applied to the substrate, and the material is baked at a high temperature of about 200° C., so that an alignment film as the first alignment control layer is formed. Then, seal printing is performed. The sealing material can be one curable by at least one of ultraviolet irradiation and heat. After alignment film baking, the alignment film may be rubbed and washed. A liquid crystal cell is formed by, after seal printing, causing the substrates to adhere to one another with the sealing material, injecting the liquid crystal composition in vacuum, and sealing the injection opening with, for example, an ultraviolet-curable resin (sealing step). Here, the liquid crystal cell may be formed by dropping the liquid crystal composition onto one of the substrates in vacuum, and then causing the substrate to adhere to the other substrate. The method for maintaining the thickness of the liquid crystal layer may be a method using a spacer, for example. Examples thereof include a method of patterning pillar-shaped photospacers, and a method of distributing spherical spacers.

Next, the liquid crystal cell is heated with a device such as an oven, and thermally annealed at a given temperature for a given time (annealing step). At this time, the liquid crystal cell is preferably heated to a temperature higher than the phase transition temperature (Tni) from the nematic phase to the isotropic liquid phase of the liquid crystal composition. More specifically, the conditions include a temperature of preferably from 100° C. to 140° C. inclusive and a time from 1 minute to 60 minutes inclusive. In the present invention, the thermal annealing is not an indispensable step, but is preferably performed before the photoirradiation step from the viewpoint of stabilizing the alignment.

Then, a polymerization step for forming a polymer layer as the second alignment control layer, such as ultraviolet irradiation, is performed to form a polymer layer, and then the step of causing adhesion of a polarizing plate is performed. For example, the liquid crystal cell at a temperature higher than the ordinary temperature, especially the liquid crystal composition, is preferably irradiated with light having a wavelength of 340 nm or longer.

Thereafter, the liquid crystal cell may be heated with a device such as an oven, and thermal annealing may be performed again at a given temperature for a given time.

Components such as various driving circuits and a backlight are mounted to the liquid crystal cell in which an alignment control layer has been formed through the steps described above, whereby the liquid crystal display device of Embodiment 1 is produced.

The liquid crystal display device of Embodiment 1, and a liquid crystal display device produced by the method for producing a liquid crystal display device of Embodiment 1 can exhibit excellent display qualities when used for a display device such as TVs, PCs, cellphones, and information displays.

In the liquid crystal display device of Embodiment 1, the array substrate, the liquid crystal layer, and the color filter substrate are stacked in the stated order from the rear side to the observation side of the liquid crystal display device. A polarizing plate is mounted on the rear side of the array substrate. A polarizing plate is also mounted on the observation side of the color filter substrate. These polarizing plates each may be further provided with a retardation plate. These polarizing plates may be circular polarizing plates.

The liquid crystal display device of Embodiment 1 may be any one of transmissive type, reflective type, and transmissive-and-reflective type liquid crystal display devices. In the case of a transmissive type or a transmissive-and-reflective type, the liquid crystal display device of Embodiment 1 further includes a backlight. The backlight is disposed on the rear side of the array substrate so that light passes through the array substrate, the liquid crystal layer, and the color filter substrate in the stated order. In the case of a reflective type or a transmissive-and-reflective type, the array substrate is provided with a reflection plate for reflecting external light. Moreover, in the region where at least reflected light is used for display, the polarizing plate of the color filter substrate 20 needs to be a circular polarizing plate having a λ/4 retardation plate.

The liquid crystal display device of Embodiment 1 may have a color filter on array structure in which the array substrate includes color filters. The liquid crystal display device of Embodiment 1 or Embodiment 2 may be a monochrome display. In this case, color filters are not necessarily arranged.

The array substrate includes an insulating transparent substrate made of a material such as glass, and components such as various wirings, pixel electrodes, and thin film transistors (TFTs) formed on the transparent substrate. The color filter substrate includes an insulating transparent substrate made of a material such as glass, and components such as color filters, a black matrix, and a common electrode formed on the transparent substrate.

The components of the alignment film can be analyzed and the components of monomers present in the polymer layer can be determined, for example, by disassembling the liquid crystal display device of Embodiment 1 and chemically analyzing the components by a method such as gas chromatograph mass spectrometry (GC-MS) or time-of-fright secondary ion mass spectrometry (TOF-SIMS). Also, the properties such as the shape of the liquid crystal cell including an alignment film and a polymer layer can be verified by microscopic observations using a scanning transmission electron microscope (STEM) or scanning electron microscope (SEM). The structure of the liquid crystal display device of the present invention is not particularly limited by components other than those described above. Hereinafter, experiments related to Embodiment 1 are described.

### Experiment 1-1

In this experiment, a test cell with no alignment film was used to verify provision of vertical alignment by a material added to the liquid crystal in a region without an alignment film (polyimide (PI)-less region).

### (Liquid Crystal Cell Production Step)

After the substrates were washed, the material of the sealing material was applied to one of the substrates, and beads were dispersed as spacers on the other substrate (counter substrate after adhesion). Then, the substrates were adhered to one another, and a liquid crystal was injected into the obtained cell. The material of the sealing material can be a heat-curable material, an ultraviolet-curable material, or both of these materials, but the material actually used here was a material curable by heat and irradiation of ultraviolet light. To the liquid crystal, a monofunctional monomer (4-acryloyloxy-4′-octyloxy biphenyl) represented by the following formula (2) was added in an amount of 1.0% by mass based on 100% by mass of the liquid crystal composition.

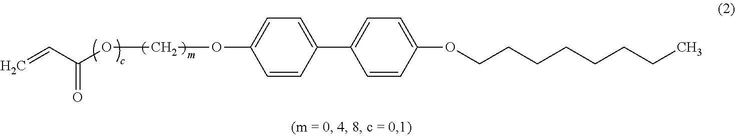

In the above formula (2), m represents 0, and c represents 0. Also, a polymerization initiator was added in an amount of 2 mol % based on 100 mol % of the monomer. Thereafter, the liquid crystal cell was irradiated with unpolarized ultraviolet light (2.57 mW/cm²) from the normal direction, so that the monomer was polymerized. In the polymerization of the monomer, the cell was irradiated while heated to 100° C. The light source used was a black light FHF-32BLB (Toshiba Lighting and Technology Corporation). The electrode used was an ITO plate-shaped electrode (planar electrode without openings. During polymerization, no voltage was applied to the liquid crystal cell. After the irradiation, the cell was observed by eyes and with a microscope under the crossed Nicols in order to determine the alignment.

### Experiment 1-2

Experiment 1-2 is the same as the above described Experiment 1-1 except that the monofunctional monomer used was a monofunctional monomer represented by the above formula (2) wherein m represents 4 and c represents 1 (4-acryloyloxybutoxy-4′-octyloxy biphenyl).

### Experiment 1-3

Experiment 1-3 is the same as the above described Experiment 1-1 except that the monofunctional monomer used was a monofunctional monomer represented by the above formula (2) wherein m represents 8 and c represents 1 (4-acryloyloxyoctoxy-4′-octyloxy biphenyl).

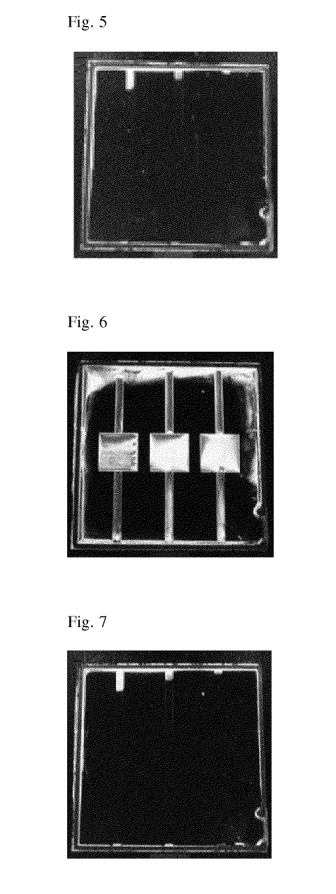

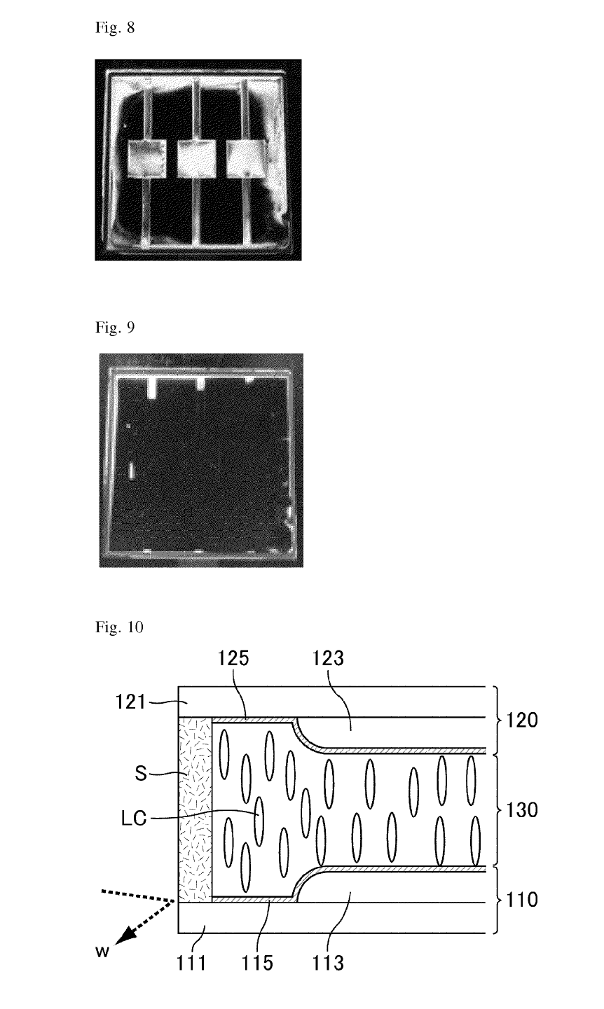

FIG. 4 and FIG. 5 showing a change in the liquid crystal cell between before and after irradiation of ultraviolet light under the crossed Nicols conditions are respective photographs showing the liquid crystal cell of Experiment 1-1 before and after ultraviolet irradiation. FIG. 6 and FIG. 7 are respective photographs showing the liquid crystal cell of Experiment 1-2 before and after ultraviolet irradiation. FIG. 8 and FIG. 9 are respective photographs showing the liquid crystal cell of Experiment 1-3 before and after ultraviolet irradiation. To the liquid crystal cells, polarizing plates arranged in the crossed Nicols are mounted. As illustrated in FIG. 5, FIG. 7, and FIG. 9 illustrating the states after the ultraviolet irradiation in the respective experiments, the liquid crystal molecules were sufficiently vertically aligned after irradiated with ultraviolet light when the monomers of Experiments 1-1 to 1-3 were used.

### Embodiment 2

FIG. 10 is a schematic cross-sectional view of a liquid crystal cell of Embodiment 2.

In Embodiment 2, the second alignment control layer is formed using an agent added to the liquid crystal in place of the monomers. Here, the liquid crystal molecules are aligned by the second alignment control layer formed from the agent in the liquid crystal composition (additive to the liquid crystal). The agent added to the liquid crystal is preferably a compound containing a hydroxy group. The number of carbon atoms in the compound is preferably from 4 to 20 inclusive.

The other suitable forms in Embodiment 2 are the same as the suitable forms of Embodiment 1.

From the viewpoints of adhesive strength and reliability, the narrow-frame panel of the present invention has a structure in which an alignment film is not formed under the sealing material and alignment is provided by the PI-less technology in the region without the alignment film (FIG. 10). The PI-less technology achieves the vertical alignment using a liquid crystal material to which a specific material has been added. That is, Embodiment 2 shows vertical alignment using a liquid crystal material obtained by adding a different material to the liquid crystal. Hereinafter, an experiment related to Embodiment 2 is described.

### Experiment 2

In Experiment 2, a test cell with no alignment film was subjected to an experiment to verify provision of vertical alignment by an agent added to the liquid crystal in a region without an alignment film (polyimide (PI)-less region). The agent added to the liquid crystal is lauryl alcohol represented by the following chemical formula (3).

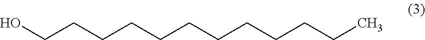

The liquid crystal cell production step is the same as that in Experiment 1 except for the liquid crystal composition injected.

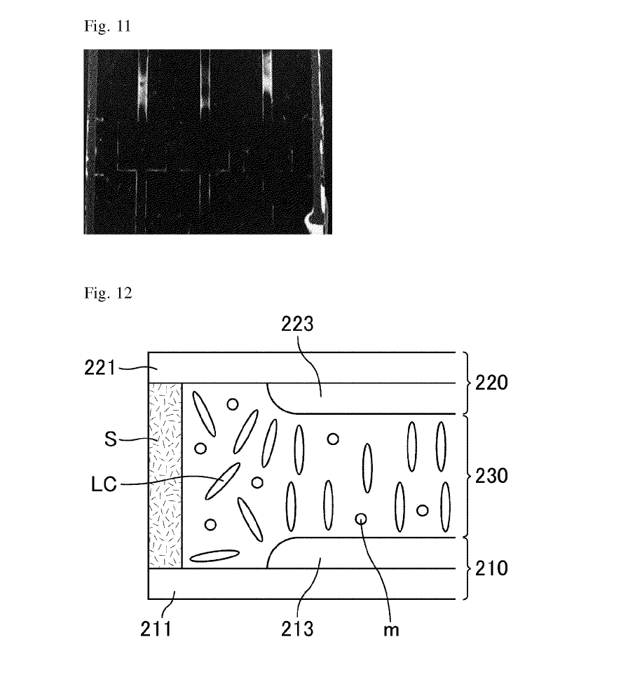

FIG. 11 is a photograph showing the liquid crystal cell of Experiment 2 after injection of a liquid crystal composition to which an additive has been added. To the liquid crystal cell, polarizing plates arranged in the crossed Nicols are mounted. That is, FIG. 11 illustrates the state under the crossed Nicols after injection of the liquid crystal composition. Even in the cell without an alignment film, the liquid crystal molecules were vertically aligned after the liquid crystal composition to which lauryl alcohol as an agent for forming an alignment control layer has been added was injected into the cell.

Here, the agent added to the liquid crystal can suitably be a C₆-C₁₈ alcohol.

### Embodiment 3

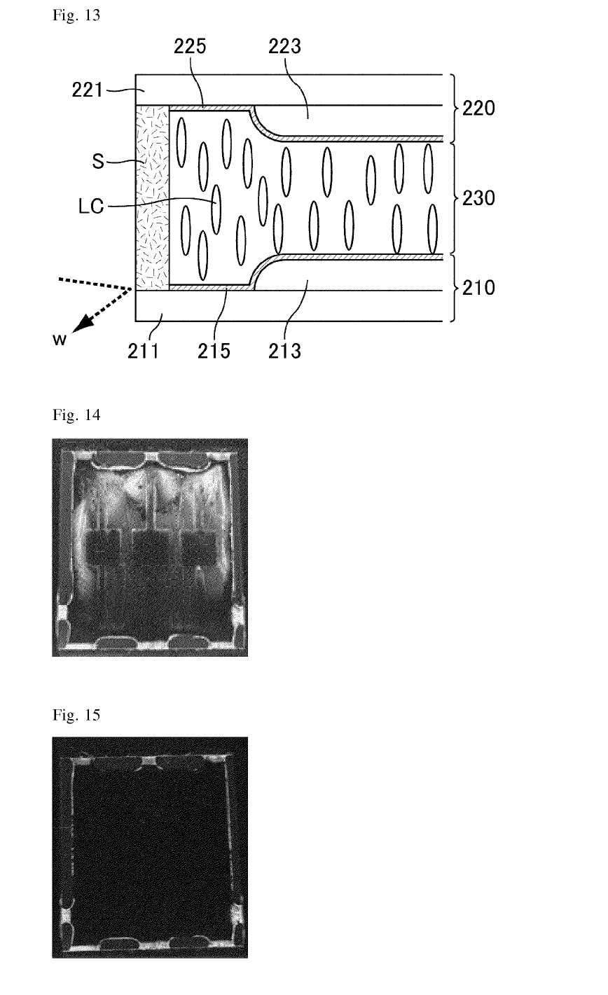

FIG. 12 is a schematic cross-sectional view of a liquid crystal cell of Embodiment 3 before photoirradiation. FIG. 13 is a schematic cross-sectional view of the liquid crystal cell of Embodiment 3 after photoirradiation. In Embodiment 3, a silane coupling layer is formed in place of a polyimide alignment film as the first alignment control layer. The other suitable forms of Embodiment 3 are the same as the suitable forms of the above Embodiments 1 and 2.

A silane coupling layer is a layer formed from components including a silane coupling compound. The silane coupling compound refers to a compound containing silicon (Si) and an organic functional group (Y). Examples of the organic functional group (Y) include epoxy groups, methacryloxy groups, acryloxy groups, amino groups, ureido groups, chloropropyl groups, mercapto groups, and isocyanato groups.

In Embodiment 3, no alignment film is formed under the sealing material in a narrow-frame panel from the viewpoints of adhesive strength and reliability, and alignment is provided by the PI-less technology to the region in which the alignment film has not been provided (FIG. 12 and FIG. 13). The PI-less technology achieves vertical alignment by injecting into a cell a liquid crystal composition to which a photopolymerizable monomer material has been added, and irradiating the cell with ultraviolet light. Here, instead of injecting into a cell a liquid crystal composition to which a photopolymerizable monomer material has been added, a photopolymerizable monomer material may be added after injection of the liquid crystal into the cell.

Embodiment 3 shows that, compared to the case of a cell with no alignment film, irradiation of the cell with ultraviolet without heating achieves vertical alignment in a cell with even partial vertical alignment.

The following will discuss an example in which a liquid crystal cell of the liquid crystal display device of Embodiment 3 was actually produced.

### Example 1

Example 1 utilizes a technology of achieving vertical alignment using a silane coupling (SC) agent. After application of an SC agent, rinsing (pure water washing) vertically aligns the liquid crystal molecules, but also produces a region in which part of the liquid crystal molecules is not vertically aligned. Based on this result, an experiment was performed to verify with a test cell that the monomers for the PI-less technology more easily achieves vertical alignment if the liquid crystal molecules in the liquid crystal layer are partially vertically aligned (monomers which usually are not vertically aligned without irradiation at high temperatures can be vertically aligned by irradiation at room temperature). Here, rinsing can also achieve excellent reliability.

The chemical formula of the monofunctional monomer used in Example 1 is represented by the following formula (4).

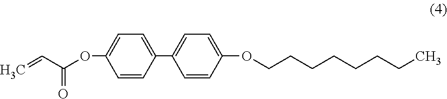 [SMILES: C=CC(=O)Oc1ccc(-c2ccc(OCCCCCCCC)cc2)cc1]

### (Liquid Crystal Cell Production Step)

Substrates were washed, and then subjected to a silane coupling agent treatment. Rinsing (pure water washing) was performed after the silane coupling agent treatment. The material of a sealing material was applied to one of the substrates, and beads were scattered as spacers on the counter substrate. Then, the substrates were adhered to one another, and a liquid crystal was injected into the obtained cell. The material of the sealing material can be a heat-curable material, an ultraviolet-curable material, or both of these materials, but the material actually used here was a material curable by heat and irradiation of ultraviolet light. To the liquid crystal, a monofunctional monomer (4-acryloyloxy-4′-octyloxy biphenyl) represented by the above formula (4) was added in an amount of 1.0% by mass based on 100% by mass of the liquid crystal composition. Thereafter, the liquid crystal cell was irradiated with unpolarized ultraviolet light (2.57 mW/cm²) from the normal direction, so that the monomer was polymerized. In polymerization, the liquid crystal was irradiated without heating. The light source used was a black light FHF-32BLB (Toshiba Lighting and Technology Corporation). The electrode used was a substrate with an ITO solid electrode. During polymerization, no voltage was applied to the liquid crystal cell. After the irradiation, the cell was observed by eyes and with a microscope under the crossed Nicols in order to determine the alignment.

### Comparative Example 1

Comparative Example 1 is the same as Example 1 except that the SC agent application step and the step of rinsing (pure water washing) were not performed.

Change in Liquid Crystal Cell Between Before and after Irradiation of Ultraviolet Light Under the Crossed Nicols Conditions

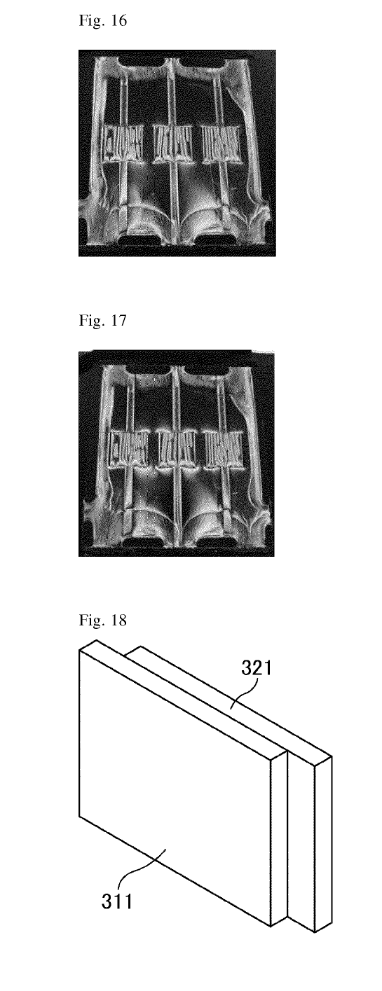

FIG. 14 and FIG. 15 are respective photographs showing the liquid crystal cell of Example 1 before and after ultraviolet irradiation. FIG. 16 and FIG. 17 are respective photographs showing the liquid crystal cell of Comparative Example 1 before and after ultraviolet irradiation. To the liquid crystal cells, polarizing plates arranged in the crossed Nicols are mounted. FIG. 14 showing the state before the ultraviolet irradiation in Example 1 shows a region in which part of the liquid crystal molecules is not vertically aligned on the upper side of the figure. Still, as shown in FIG. 15 showing the state after the ultraviolet irradiation in Example 1, the liquid crystal molecules were sufficiently vertically aligned after the irradiation of ultraviolet light.

The results of the examples and comparative examples can lead to the following conclusion. That is, as shown in FIG. 14 and FIG. 15, irradiation of a test cell including liquid crystal molecules partially vertically aligned by the effect of the SC agent (FIG. 14 in which part of the liquid crystal molecules is not vertically aligned on the upper side of the figure) resulted in vertical alignment on the entire surface by irradiating the cell with ultraviolet light (FIG. 15). Meanwhile, as shown in FIG. 16 and FIG. 17, when a test cell in which vertical alignment is not achieved before irradiation (FIG. 16) is irradiated with ultraviolet light at room temperature, vertical alignment is not achieved (FIG. 17). This result reveals that, if the same materials are used under the same irradiation conditions, vertical alignment is more likely to be achieved by the polymer layer as the second alignment control layer in a cell including a region in which part of the liquid crystal molecules is vertically aligned than in a cell in which none of the liquid crystal molecules is vertically aligned.

As described above, the present invention features a structure in which no alignment film is formed under the sealing material in a narrow-frame panel from the viewpoints of adhesive strength and reliability, and alignment is provided by the PI-less technology to the region without the alignment film. The PI-less technology achieves vertical alignment by injecting into a cell a liquid crystal composition to which a photopolymerizable monomer material has been added, and irradiating the cell with ultraviolet light. The following describes Experiment 3 and Comparative Experiment 1 which show the results that the adhesive strength is enhanced in a cell with no alignment film compared to a cell with an alignment film.

### Experiment 3 and Comparative Experiment 1

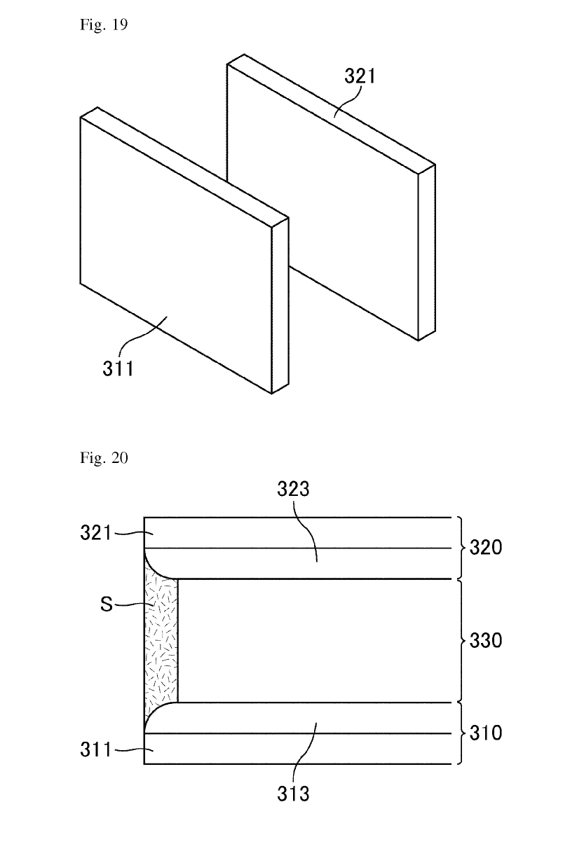

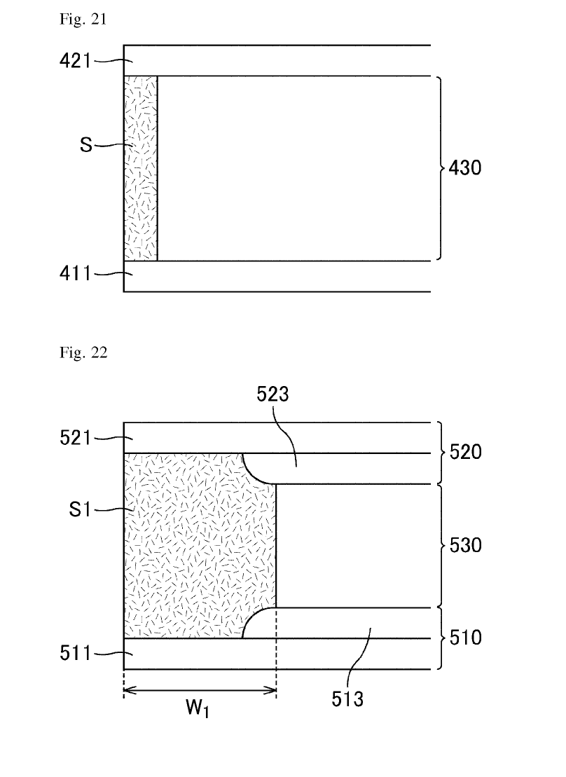

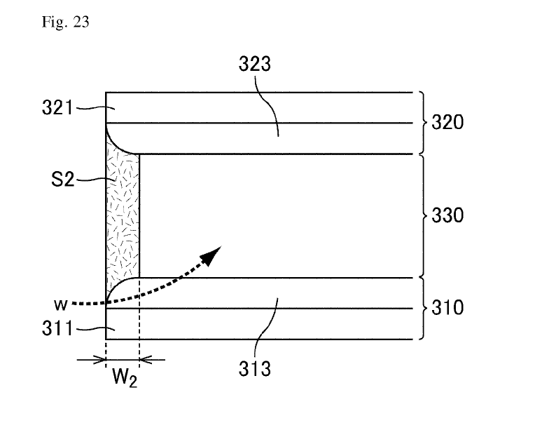

FIG. 18 is a schematic perspective view illustrating a pair of substrates adhered to one another. FIG. 19 is a schematic perspective view illustrating separation of the pair of substrates illustrated in FIG. 18 by pressure. In FIG. 18 and FIG. 19, components such as the liquid crystal layer are not illustrated. FIG. 20 is a schematic cross-sectional view of a liquid crystal cell of Comparative Experiment 1. FIG. 21 is a schematic cross-sectional view of a liquid crystal cell of Experiment 3. In FIG. 20, the alignment films 313 and 323 made of polyimide are formed under the sealing material S, and the sealing material S is not in direct contact with glass substrates 311 and 321. In FIG. 21, the sealing material S is in a direct contact with glass substrates 411 and 421.

### (Liquid Crystal Cell Production Step Common in Experiment 3 and Comparative Experiment 1)

After the substrates were washed, the material of a sealing material was applied to one of the substrates, and beads were scattered as spacers on the counter substrate. Then, the substrates were adhered to one another. The material of the sealing material can be a heat-curable material, an ultraviolet-curable material, or both of these materials. In Experiment 3 and Comparative Experiment 1, a material curable by heat and irradiation of ultraviolet light was used. After curing of the sealing material, the substrates were separated by applying pressure. The pressure applied for separation was measured. Also, high-humidity and high-temperature aging was performed, and the separation strength after the aging was also measured.

The adhesive strengths (adhesive strength in the presence or absence of an alignment film) in Experiment 3 and Comparative Experiment 1 are shown in the following Table 1.

TABLE 1

| | | After high-temperature and |
|---|---|---|
| | Initial value | high-humidity aging |
| With alignment film | 2.6 kgf | 0.3 kgf |
| Without alignment film | 2.9 kgf | 1.8 kgf |

Whether or not the adhesive strength of the panel changes based on the presence or absence of the alignment film is evaluated in the following manner.

As shown in Table 1, the presence or absence of the alignment film does not greatly differentiate the initial value. However, the high-humidity and high-temperature aging appears to have greatly decreased the separation strength of the cell with an alignment film. This is probably because moisture has entered from the alignment film or from the interface, decreasing the adhesive strength.

The supplementary description for the experiments and examples described above are provided below. Experiments 1-1 to 1-3 and Experiment 2 employed a typical panel without an alignment film, and Experiments 1-1 to 1-3 and Experiment 2 are different in the materials and the mechanism for vertical alignment as described above. That is, the materials used in Experiments 1-1 to 1-3 are materials (monomers) polymerized by irradiation of ultraviolet light, and the liquid crystal molecules are not vertically aligned right after injection of the monomers and the liquid crystal into the cell. Irradiation with ultraviolet light to polymerize the monomers to form polymer layers on the substrate surfaces vertically aligns the liquid crystal molecules. In contrast, the materials used in Experiment 2 are not monomers, and thus irradiation with ultraviolet light is not necessary. The liquid crystal molecules are already vertically aligned right after injection of the liquid crystal composition into the cell. Experiment 3 shows the results of measurement of the adhesive strength.

The liquid crystal display device of the present invention always has an alignment film as a first alignment control layer. One feature of the present invention is that the alignment film as the first alignment control layer is not formed at least under the sealing material even if the width of the sealing material is narrow. In the region without an alignment film in the display region, vertical alignment is provided by forming the second alignment control layer from a specific material added to the liquid crystal. Another feature is that, when an alignment film as the first alignment control layer is provided even in a part (in other words, there is a region in which the liquid crystal molecules are vertically aligned in a part), the partial alignment has an effect of facilitating the vertical alignment by the material added to the liquid crystal.

That is, for example, even a material (the second alignment control layer) incapable of providing vertical alignment in a liquid crystal panel with no alignment film such as polyimide can provide vertical alignment, or can provide vertical alignment through a simple process (e.g. no heating is required) if an alignment film as the first alignment control layer is partially present. The example performed employed a silane coupling agent (Example 1). The silane coupling agent is not usually used as a typical alignment film as in the case of polyimide, and is typically used as a surface modifier. Still, such a silane coupling agent can function as the first alignment control layer, and can vertically align the liquid crystal molecules in a suitable manner when combined into a polymer layer obtained from the monomer material used in Example 1 (monofunctional monomer). The monomer material used in Example 1 does not achieve vertical alignment by irradiation with ultraviolet light without heating, but when the liquid crystal molecules are partially aligned, the monomer material can provide vertical alignment without heating. These results are shown in the experiment results of Example 1.

From the overall results of the above embodiments, examples, and experiments, the liquid crystal display device includes the first alignment control layer including an outer edge that is on the inner side relative to an inner periphery of the sealing material in the plan view of the main surfaces of the pair of substrates, and the liquid crystal display device includes, in a display region, a region without the first alignment control layer. Here, the second alignment control layer partially covers the first alignment control layer, and in a plan view of the main surfaces of the substrates, the outer edge of the second alignment control layer is formed on the outer side relative to the outer edge of the first alignment control layer. Accordingly, the liquid crystal molecules can be easily aligned, and sufficient display qualities can be achieved. Also, since there is no first alignment control layer sandwiched between the sealing material and the substrate, the adhesive strength between the pair of substrates is sufficiently high, and thus a liquid crystal display device with excellent reliability can be obtained.

Factors such as the monomer components present in the alignment control layer, the ratio of the monomer components present in the alignment control layer, and the blended amount of the monomers for forming an alignment control layer in the liquid crystal layer can be determined by disassembling the liquid crystal display devices of

Embodiments 1 to 3 (e.g., cellphones, monitors, liquid crystal televisions (TVs), information displays), and then performing a chemical analysis using a method such as nuclear magnetic resonance (NMR), Fourier transform infrared spectroscopy (FT-IR), or mass spectrometry (MS).

The liquid crystal display devices of Embodiments 1 to 3 can be used with various modes which utilize alignment control structures capable of tilting the liquid crystal molecules in a certain direction relative to the substrate surfaces with an applied voltage and/or no applied voltage. Specifically, the liquid crystal display devices can be applied to modes such as a multi-domain vertical alignment (MVA) mode in which the alignment of liquid crystal molecules is controlled using wall-like (in a plan view, line-shaped) dielectric projections (ribs) projecting toward the liquid crystal layer as alignment control projections on the electrode, and slits provided to the electrode; a patterned vertical alignment (PVA) mode in which the alignment of liquid crystal molecules is controlled using slits as alignment control projections on both of the substrates; a continuous pinwheel alignment (CPA) mode in which the alignment of liquid crystal molecules is controlled using pillar-shaped (in a plan view, dot-like) structures (rivets) as dielectric projections or holes on the electrode; and a transverse bend alignment (TBA) mode in which the alignment of liquid crystal molecules vertically aligned with no applied voltage is controlled by generating a transverse electric field with comb-shaped electrodes. These structures stabilize the alignment of liquid crystal molecules, and thereby reduce the possibility of display defects.

The technical features described in the embodiments can be combined with one another, and combination of these technical features can form new technical features. For example, the liquid crystal display device may include a silane coupling layer as the first alignment control layer, and include lauryl alcohol as the second alignment control layer.

### REFERENCE SIGNS LIST

11, 21, 111, 121, 211, 221, 311, 321, 411, 421, 511, 521: Glass substrate
10, 110, 210, 310, 510: TFT substrate
20, 120, 220, 320, 520: Color filter substrate
30, 130, 230, 330, 430, 530: Liquid crystal layer
13, 23, 113, 123, 313, 323, 513, 523: Alignment control layer (alignment film)
15, 25, 215, 225: Alignment control layer (polymer layer)
115, 125: Alignment control layer (lauryl alcohol layer)
213, 223: Alignment control layer (silane coupling layer)
LC: Liquid crystal molecule
m: Monomer
S: Sealing material
w: Moisture
W₁, W₂: Width

1. A liquid crystal display device comprising:
a liquid crystal cell that includes
a pair of substrates;
a liquid crystal layer sandwiched between the pair of substrates; and
a sealing material causing the pair of substrates to adhere to one another,
the sealing material surrounding the liquid crystal layer in a plan view of main surfaces of the pair of substrates, at least one of the pair of substrates being provided with, on the liquid crystal layer side, an electrode, a first alignment control layer, and a second alignment control layer,
the first alignment control layer including an outer edge that is on the inner side relative to an inner periphery of the sealing material in a plan view of the main surfaces of the pair of substrates,
the liquid crystal display device including, in a display region, a region without the first alignment control layer,
the second alignment control layer partially covering the first alignment control layer, and including an outer edge that is on the outer side relative to the outer edge of the first alignment control layer in a plan view of the main surfaces of the pair of substrates.

2. The liquid crystal display device according to claim 1,
wherein the sealing material has a width of 1.0 mm or smaller in a plan view of the main surfaces of the substrates.

3. The liquid crystal display device according to claim 1,
wherein the second alignment control layer is formed from a monomer unit derived from at least one of a monofunctional monomer and a polyfunctional monomer, the at least one monomer containing a C₈-C₂₀ alkyl group and a functional group that generates radicals by photoirradiation.

4. The liquid crystal display device according to claim 1,
wherein a distance from the inner periphery of the sealing material to the first alignment control layer is 0.05 mm or longer.

5. The liquid crystal display device according to claim 1,
wherein a distance from the inner periphery of the sealing material to the display region is 1.0 mm or shorter.

6. The liquid crystal display device according to claim 1,
wherein at least part of an outer periphery of the sealing material and at least part of the outer edge of the pair of substrates match one another in a plan view of the main surfaces of the substrates.

7. The liquid crystal display device according to claim 1,
wherein the liquid crystal molecules are aligned in a perpendicular direction to the main surfaces of the substrates when voltage applied to the liquid crystal molecules is lower than a threshold voltage.

8. The liquid crystal display device according to claim 1,
wherein the liquid crystal molecules have a negative anisotropy of dielectric constant.

9. A method for producing a liquid crystal display device comprising
a liquid crystal cell that includes
a pair of substrates;
a liquid crystal layer sandwiched between the pair of substrates, and
a sealing material causing the pair of substrates to adhere to one another,
the method comprising the steps of:
forming a first alignment control layer for controlling alignment of liquid crystal molecules to bring an outer edge of the first alignment control layer on the inner side relative to an inner periphery of the sealing material;
forming the sealing material;
injecting a liquid crystal composition;
annealing the liquid crystal cell; and
forming a second alignment control layer including an outer edge that is on the outer side relative to the outer edge of the first alignment control layer by polymerization of monomers or by an agent in the liquid crystal composition.

10. The method for producing a liquid crystal display device according to claim 9,
wherein the step of forming a second alignment control layer includes polymerizing monomers by photoirradiation.

11. The method for producing a liquid crystal display device according to claim 9,
wherein the step of forming a second alignment control layer includes polymerizing monomers by a polymerization initiator.

12. The method for producing a liquid crystal display device according to claim 9,
wherein the step of forming a second alignment control layer includes forming the second alignment control layer by an additive containing a hydroxy group.

13. The method for producing a liquid crystal display device according to claim 9,
wherein the monomers constitute from 0.5% by mass to 2.5% by mass inclusive of the liquid crystal composition.

14. The method for producing a liquid crystal display device according to claim 10,
wherein the photoirradiation is performed by heating the liquid crystal composition to a temperature not lower than a temperature that is lower than the nematic-isotropic phase transition temperature by 30° C.
